(19) United States
(12) Patent Application Publication
(10) Pub. No.: US 2009/0277996 A1
(43) Pub. Date: Nov. 12, 2009

(54) Wing and empennage leading edge structure made of thermoplastic material with a stiffened double shell configuration

(75) Inventors: Ernesto Rinaldi, Agropoli (Salerno) (IT); Salvatore Russo, Quarto (Napoli) (IT); Generoso Iannuzzo, Avellino (IT); Massimo Riccio, Caserta (IT); Giovanni Sagnella, Benevento (IT)

Correspondence Address: Edward D. Manzo, Esq.;COOK, ALEX, MCFARRON, MANZO,, CUMMINGS & MEHLER, Ltd., 200 West Adams Street, Suite 2850, Chicago, IL, 60606, US

(73) Assignee: Alenia Aeronautica S.p.A.

(21) Appl. No.: 12/387,589

(22) Filed: May 5, 2009

(30) Foreign Application Priority Data
May 6, 2008 (IT) TO2008A000333

(51) Int. Cl. B64C 3/20; B64C 5/00; B29C 39/00

(52) U.S. Cl. 244/123.1; 264/250

(57) ABSTRACT

A leading edge structure is described for wing structures and empennage, comprising an outer shell suitable to define a front portion of a airfoil. The outer shell is formed by a bent plate of fiber-reinforced thermoplastic resin composite material. The structure further comprises

an inner shell having a convex profile that is oriented in the same direction as the profile of outer shell, which is formed by a bent plate of fiber-reinforced thermoplastic resin composite material and is bonded to the outer shell at the longitudinal edges thereof, and

at least one reinforcing element, transversally extending such as to connect the outer shell and inner shell to each other , which is formed by at least one piece of fiber-reinforced resin composite material and is fixed at opposite ends to the outer shell and inner shell, respectively.

The present invention relates to wing and empennage leading edge structure, comprising an outer shell suitable to define a front portion of an airfoil, said outer shell being made of a bent plate of a fiber-reinforced resin composite material.

Wings and empennage (both vertical and horizontal) are primary structures that are normally dimensioned in terms of stiffness and strength according to the aerodynamic loads to which they can be subjected during flight and/or landing (or take-off) steps.

A particular mention should be made of the requirements to be met by the leading edges of these structures: in these cases, this structure is generally defined and dimensioned by the resistance to possible bird strike during the flight and landing (or take-off) steps.

The so-called bird strike testing is regulated according to FAR 25.631 and sets forth that: when an aircraft impacts with a bird of a defined weight and at a set velocity, following this condition no damage shall occur to the primary structures such as to affect the aircraft safe landing at the nearest airport. As the leading edge is the first structural element which is most likely to be subjected to this kind of impact in cruise conditions, this structure must accordingly comply with the above-defined regulation.

Obviously, besides the above requisite, the leading edge requires to be suitably dimensioned such as to withstand the aerodynamic loads applied thereto.

The above-mentioned structures are usually designed and manufactured such as to prevent the leading edge from being perforated, and thus avoiding possible damages to the structure at the back, or, when perforation is expected, they are designed such that the damage is locally limited.

Traditionally, wing structures are made of aluminum (generally, shells are a few mm thick) reinforced with transversal elements, which have the main task of shaping the profile. A typical example is C-27J Spartan leading edge structure.

Other feasible solutions are, for example, those used in ATR 42-72 regional aircrafts, in which the leading edge is made of double-sandwich glass fiber, or Airbus A380, which has a vertical leading edge of Glare® (a glass fiber/aluminum laminate), and a wing leading edge of a thermoplastic material, or still in Boeing aircrafts of last generation, in which the leading edge of the horizontal empennage is a sandwich of fiber glass with a thin outer aluminum layer, or finally in Airbus A400M, in which the fixed wing leading edge is of an aluminum-carbon fiber mixed structure.

In general terms, accordingly, the materials used for known structures can be metal (aluminum), hybrid (Glare®) or sandwich (glass fiber and honeycomb, carbon fiber and honeycomb) materials, and are used to manufacture a configuration with a single primary bearing element (shell).

The object of the present invention is to provide an alternative to known solutions, which has advantages both in terms of structural configuration and in terms of materials and processes used.

The object of the present invention is thus a leading edge structure of the type defined at the beginning, further comprising
an inner shell having a convex profile being oriented in the same direction as the outer shell profile, which is formed by a bent plate of a fiber-reinforced thermoplastic resin composite material and is bonded to the outer shell at the longitudinal edges thereof, and
at least one reinforcing element which extends crosswise such as to connect the outer shell and inner shell to each other, which is made of at least one piece of fiber-reinforced resin composite material and is fixed at opposite ends to the outer shell and inner shell, respectively.

Preferred embodiments of the invention are as defined in the depending claims.

A further object of the present invention is also a method for manufacturing a leading edge structure according to the invention, comprising the following steps:
preparing and moulding a first plate of fiber-reinforced thermoplastic resin composite material intended to provide said outer shell,
preparing and moulding a second plate of fiber-reinforced thermoplastic resin composite material intended to provide said inner shell,
preparing and moulding at least one piece of fiber-reinforced resin composite material intended to provide said at least one connecting element, and
assembling and fixing said outer shell, inner shell and at least one connecting element to each other, such that the inner shell is bonded to the outer shell at the longitudinal edges thereof, and such that said at least one connecting element is bonded at opposite ends to the outer shell and inner shell, respectively.

A preferred, though non limiting, embodiment of the invention will be now described, with reference to the annexed drawings in which:

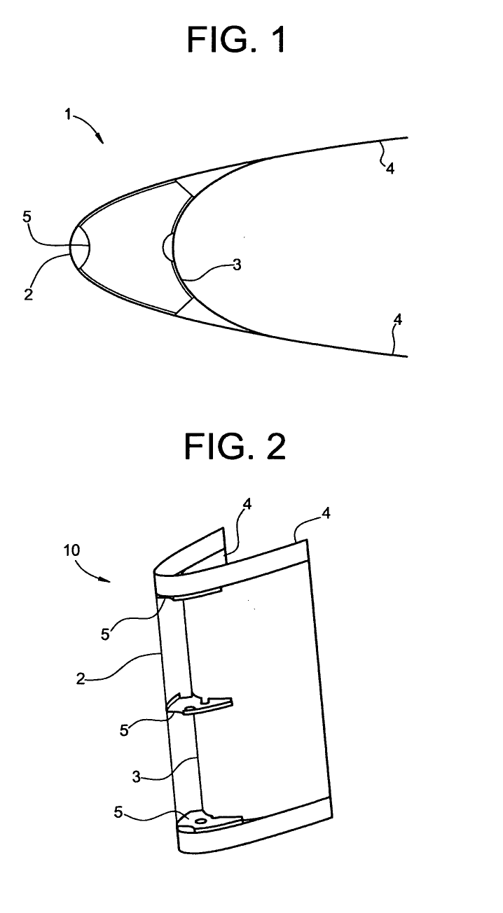

FIG. 1 is a cross-sectional schematic view illustrating a leading edge structure according to the invention;

FIG. 2 is a perspective view of a leading edge structure module according to the invention;

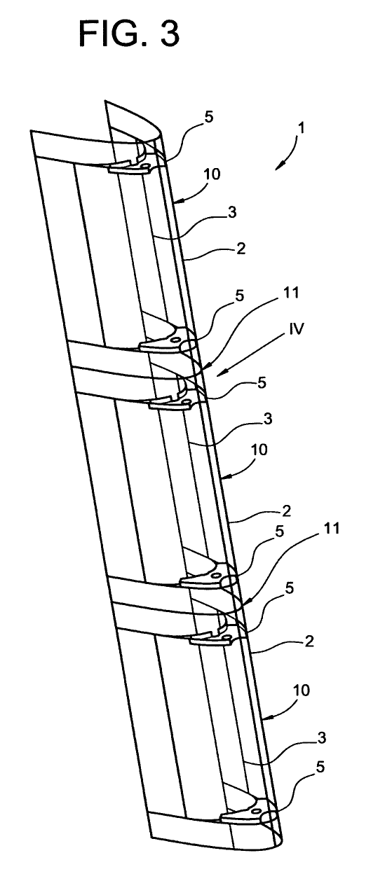

FIG. 3 is a perspective view illustrating several leading edge structure modules when fixed to each other;

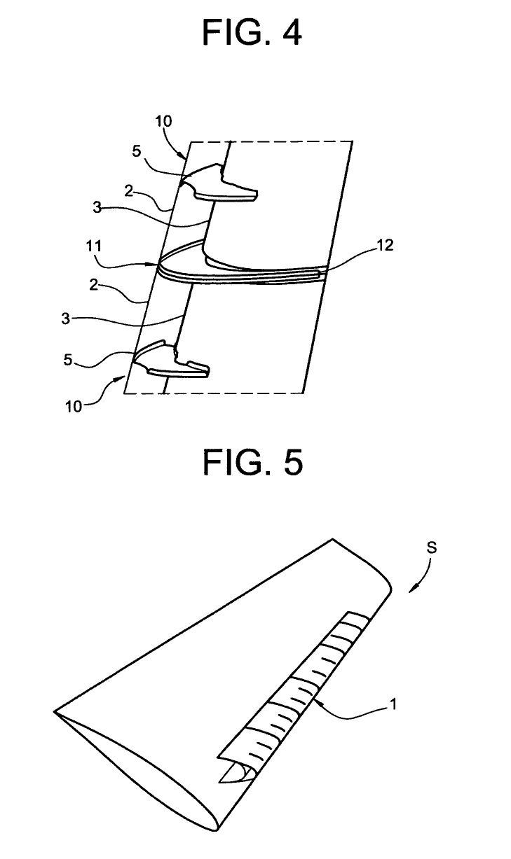

FIG. 4 is a view of a detail of FIG. 3, as indicated by the arrow IV; and

FIG. 5 is a perspective view of the leading edge structure when applied to a wing structure.

It should be noted that the figures relate to various configurations of the structure being the object of this patent (number, shape and position of the cross elements) such as to point out the flexibility thereof relative to the various applications provided herein (in terms of position, size, processes, materials).

In FIG. 1 is schematically illustrated a cross section of a wing and empennage leading edge structure globally indicated with 1.

In the following description, the terms “front”, “outer” and “inner” will be used. The term “front” is obviously related to the aircraft movement direction, whereas the terms “outer” and “inner” are general references to a condition in which the leading edge structure is assembled to the remaining wing structure or empennage, whereby the “inner” elements result to be closed within the wing structure or empennage.

The leading edge structure 1 comprises an outer shell 2 suitable to define a front portion of a airfoil. This outer shell 2 is formed by a bent plate of a fiber-reinforced thermoplastic resin composite material. Examples of this material comprise, but are not limited thereto, PPS (Polyphenylene sulphide), PEEK (Polyether-etherketone), PEKK (Polyether ketone ketone) that may be either previously impregnated or infused with short, long fibers or fabrics or mats of carbon or glass fibers, and optionally stiffened with metal strands.

The structure 1 further comprises an inner shell 3 having a convex profile oriented in the same direction as the profile of outer shell 2. In other words, the convexity of the inner shell 3 is oriented in the same direction (i.e. forwards) as the convexity of the outer shell 2.

The inner shell 3 is also formed by a bent plate of fiber-reinforced thermoplastic resin composite material. As examples of this material, reference should be made to what has been described above for the outer shell 2.

The inner shell 3 is bonded to the outer shell 2 at the longitudinal edges 4 thereof. This bonding is simply obtained by means of the thermoplastic resin of the material of the two shells 2, 3. Thereby, an optimum continuity is obtained between these shells at the mutual bonding areas.

The structure 1 further comprises one or more reinforcing elements 5 transversally extending such as to connect the outer shell 2 and inner shell 3 to each other. Each of these reinforcing elements 5 is formed by a piece of fiber-reinforced resin composite material. Preferably, it is a thermoplastic resin, but it may also be a thermosetting resin, e.g. an epoxy resin. As examples of reinforced thermoplastic resin, reference should be made to what has been described above for the outer shell 2.

Each of the reinforcing elements 5 is fixed at opposite ends to the outer shell 2 and inner shell 3, respectively. This fixing is obtained, for example by means of bolting or bonding. When the resin of the reinforcing elements 5 is also a thermoplastic resin, the bonding is advantageously obtained by means of the thermoplastic resin of the material of the two shells 2, 3. Thereby, an optimum continuity is obtained between each reinforcing element and the outer shell on the one side, and between each reinforcing element and the inner shell, on the other side.

The above-described structure is based on a progressive shock-absorption concept, by providing several successive walls being suitably spaced from each other, and supported to one another, such that the impact energy is gradually distributed throughout the penetration step following the impact. The impact substantially takes place against the first shell which absorbs an energy aliquot, while in the meantime the reinforcing elements transmit a portion of this energy to the inner shell. Upon breaking of the outer shell the part of the bird passing therethrough (with a considerably lessened impact energy) is stopped by the inner shell.

According to a preferred manufacturing process, the structure 1 is manufactured by means of a matched moulding process. Each of the parts, i.e. the outer shell 2, the inner shell 3 and the reinforcement elements 5 is manufactured separately by means of matched moulding, at such a temperature as to cause the softening of the resin composing the material of these parts.

After these parts are cooled, they are then assembled to each other, and welded at mutual contact points (e.g., by laser, induction, infrared techniques, etc.), such as to provide an intimate connection therebetween.

Preferably, when large sized components are used, the structure 1 is manufactured in single separated modules, each of which comprises an outer shell 2, an inner shell 3, and at least one cross-connecting element 5. In FIG. 2 an example of one of these modules is illustrated, which is globally indicated with 10. The outer shell 2 is illustrated in phantom, such as to make the inner parts visible.

As illustrated in FIGS. 3 and 4, the individual modules 10 are aligned and fixed to each other via mechanical connection means, such as bolts (not illustrated), such as to provide the leading edge structure 1 complete with a wing structure or empennage. In FIG. 4 a possible example of junction 11 between two adjacent modules 10 is illustrated, which junction is obtained by means of an intermediate plate 12 that is mechanically connected to both modules 10.

As illustrated in FIG. 5, the completed structure 1 is then assembled to the remainder of the wing structure or empennage S by means of mechanical connection means (not illustrated).

1. A leading edge structure for wing structures and empennages, comprising an outer shell suitable to define a front portion of a airfoil, said outer shell being formed by a bent plate of a fiber-reinforced thermoplastic resin composite material, wherein it further comprises
an inner shell having a convex profile being oriented in the same direction as the profile of the outer shell, which is formed by a bent plate of a fiber-reinforced thermoplastic resin composite material and is bonded to the outer shell at the longitudinal edges thereof, and
at least one reinforcing element transversally extending such as to connect the outer shell and the inner shell to each other, formed by at least one piece of a fiber-reinforced resin composite material and fixed to the outer shell and inner shell.

2. The structure according to claim 1, formed by a plurality of separate modules, each of said modules comprising said inner shell, outer shell and at least one connecting element, which are arranged aligned in the longitudinal direction of said structure, and fixed to each other by means of mechanical connecting means.

3. The structure according to claim 1, wherein the resin of said at least one reinforcing element is a thermoplastic resin.

4. The structure according to claim 3, wherein said at least one reinforcing element is bonded at opposite ends to the outer shell and inner shell, respectively.

5. A method for manufacturing a leading edge structure according to one of the preceding claims, comprising the following steps:
preparing and moulding a first plate of fiber-reinforced thermoplastic resin composite material, intended to provide said outer shell,
preparing and moulding a second plate of fiber-reinforced thermoplastic resin composite material, intended to provide said inner shell,
preparing and moulding at least one piece of fiber-reinforced resin composite material, intended to provide said at least one connecting element, and
assembling and fixing said outer shell, inner shell, and at least one connecting element to each other, such that the inner shell is bonded to the outer shell at the longitudinal edges thereof, and such that said at least one connecting element is bonded at opposite ends to the outer shell and inner shell, respectively.

6. The structure according to claim 2, wherein the resin of said at least one reinforcing element is a thermoplastic resin.

7. The structure according to claim 6, wherein said at least one reinforcing element is bonded at opposite ends to the outer shell and inner shell, respectively.
